(19) United States
(12) Patent Application Publication
(10) Pub. No.: US 2018/0372411 A1
(43) Pub. Date: Dec. 27, 2018

(54) SCUM REMOVAL DEVICE AND SCUM REMOVAL METHOD

(71) Applicant: NIPPON STEEL & SUMITOMO METAL CORPORATION, Tokyo (JP)

(72) Inventors: Yusuke IRIE, Tokyo (JP); Mikio KAWAMURA, Tokyo (JP); Keisuke YOSHIDA, Tokyo (JP)

(73) Assignee: NIPPON STEEL & SUMITOMO METAL CORPORATION, Tokyo (JP)

(21) Appl. No.: 16/064,333

(22) PCT Filed: Dec. 21, 2016
(86) PCT No.: PCT/JP2016/088243

§ 371 Date: Jun. 20, 2018

(30) Foreign Application Priority Data
Dec. 24, 2015 (JP) 2015-251230

(51) Int. Cl. F27D 3/15; C23C 2/40

(52) U.S. Cl. CPC F27D 3/1572; C23C 2/06; C23C 2/40

(57) ABSTRACT

A scum removal device according to the present disclosure includes a snout, a discharge section, and a suction section. The discharge section is disposed on an extension line of a steel strip entry position on a hot-dip plating bath surface at one side in a steel strip width direction, and discharges a liquid metal for hot dipping. The suction section is disposed on the extension line on the hot-dip plating bath surface at another side in the steel strip width direction, and sucks in the liquid metal for hot dipping. The suction section is configured by a first suction portion and a second suction portion. The first suction portion and the second suction portion are disposed separated from each other at each side of the steel strip width direction extension line of the steel strip entry position on the hot-dip plating bath surface.

### TECHNICAL FIELD

The present disclosure relates to a scum removal device and a scum removal method to remove scum floating at the inside of a snout configuring equipment to manufacture hot-dip plated steel sheet.

### BACKGROUND ART

In equipment to manufacture hot-dip galvanized steel sheet, if zinc vaporized from a hot-dip galvanizing bath condenses on and adheres to inner walls of a snout (steel strip direct feed pipeline connecting a reduction annealing furnace to a pot of molten zinc), the zinc sometimes forms a scum powder that floats on the galvanizing bath.

Technology is accordingly employed in which a discharge port and a suction port are provided at each of the two steel strip width direction sides of the steel strip inside the snout, a flow is formed in the steel strip width direction, and scum is sucked out through the suction port. However, this is not sufficiently effective, and so technology like the following has been proposed.

For example, Japanese Patent Application Laid-Open (JP-A) No. 2010-229530 (hereinafter referred to as Patent Document 1) discloses a countermeasure to remove floating matter by providing discharge port and suction port pairs, with one pair provided on each of the two thickness direction sides of a steel strip.

Moreover, JP-A No. 2000-064015 (hereinafter referred to as Patent Document 2) and JP-A No. 2014-114484 (hereinafter referred to as Patent Document 3) disclose configurations in which a discharge port is provided on one width direction side of a steel strip to discharge a liquid metal for hot dipping, and a suction port is provided on the other width direction side of the steel strip to suck in the liquid metal for hot dipping.

Moreover, JP-A No. 2003-293107 (hereinafter referred to as Patent Document 4) discloses a configuration in which two discharge ports are provided on one width direction side of a steel strip, and one suction port is provided on the other width direction side of the steel strip.

Moreover, in order to address issues when an injection nozzle is provided for injecting liquid metal for hot dipping, JP-A No. 2014-201817 (hereinafter referred to as Patent Document 5) discloses a configuration in which a dross transfer device is provided to generate waves by moving a plate shaped member to and fro.

### SUMMARY OF INVENTION

### Technical Problem

However, in the method of Patent Document 1, a flow is generated from one discharge port toward the suction port provided in the steel strip width direction thereof, and a flow is generated from the one discharge port toward the suction port provided in the steel strip thickness direction thereof. This results in part of the scum flowing toward the steel strip surface, and in particular at the two sides in the steel strip width direction, scum readily adheres to the steel strip surface on the side where the discharge port is provided.

Moreover, due to the discharge port being close to the snout wall face, the flow at the wall face is fast, and dislodges scum that has adhered to the wall face. This scum flows out on the bath surface, and readily adheres to the steel strip. This becomes a particular issue because of the large size of the scum dislodged from the snout inner wall face adjacent to the plating bath.

Moreover, Patent Document 2 and Patent Document 3 provide technology to form a flow with directionality from one width direction side of the steel strip to the other width direction side thereof. However, an accompanying current is generated at the hot-dip plating bath surface as the steel strip is drawn into the hot-dip galvanizing liquid. Thus, if the hot-dip zinc plating liquid is simply discharged from one width direction side of the steel strip toward the other width direction side of the steel strip, the effect of the accompanying current will dominate at the suction port side, and scum will flow toward the steel strip surface.

Moreover, although Patent Document 2 proposes a configuration in which a divider plate is install parallel to the steel strip, scum adhered to the divider plate surface readily detaches from the divider plate due to the fast flow in the regulated flow direction, and surface defects are readily generated by the detached scum adhering to the steel strip surface.

Moreover, Patent Document 2 proposes technology to forcibly generate a bath surface flow in a substantially orthogonal direction away from the surface of the steel strip. However, due to a strong flow being generated so as to flow from the two width direction ends of the steel strip in a direction toward the plate width direction center, a problem arises in that inflowing scum readily adheres at the two steel strip width direction end portions of the steel strip.

In the configuration of Patent Document 4, the suction port is provided on an extension line in the width direction, and so there is a concern that the flow from the two discharge ports toward the suction port might draw progressively closer to the steel strip as it flows from the discharge ports toward the suction port.

Moreover, in the configuration of Patent Document 5, waves are generated by moving a plate shaped member to and fro with the dross transfer device, and so floating scum is simply displaced up and down together with the generated waves, and it is not possible to cause active scum flow.

The present disclosure provides a scum removal device and a scum removal method capable of suppressing scum floating on a hot-dip plating bath surface from adhering to a steel strip by suppressing over the entire width of the steel strip.

### Solution to Problem

As a result of diligent investigations, the inventors have discovered that scum adhered to snout wall faces in the vicinity of a plating bath surface pose a particular problem in causing steel strip defects when the scum dislodges and adheres to the steel strip. The inventors et al. have discovered that this problem can be prevented by making the scum adhered to the snout wall face at the boundary between the snout inner face and the bath surface more difficult to dislodge, and controlling flow at the bath surface such that even if scum is dislodged, the dislodged scum does not flow to the steel strip surface.

A scum removal device according to a first aspect of the present disclosure includes: a snout, the snout being inserted into a liquid metal for hot dipping in a hot-dip plating pot such that a hot-dip plating bath surface is present inside the snout; a discharge section, the discharge section being disposed on an extension line of a steel strip entry position on the hot-dip plating bath surface at one side in a steel strip width direction, and discharging the liquid metal for hot dipping; and a suction section, the suction section being disposed on the extension line on the hot-dip plating bath surface at another side in the steel strip width direction, and sucking in the liquid metal for hot dipping; the suction section being configured by a first suction portion and a second suction portion, and the first suction portion and the second suction portion being disposed separated from each other at each side of the steel strip width direction extension line of the steel strip entry position on the hot-dip plating bath surface.

The scum removal device according to the present disclosure enables scum floating on the surface of a hot-dip plating bath to be suppressed from adhering to a steel strip.

### BRIEF DESCRIPTION OF DRAWINGS

FIG. 1 is a schematic cross-section of an example of steel strip plating equipment, as viewed from the side.

FIG. 2 is a schematic cross-section of the interior of a snout, as viewed along the direction of line 2-2 of FIG. 1.

FIG. 3 is a schematic cross-section of a hot-dip plating bath surface inside a snout, as viewed along the direction of line 3-3 of FIG. 2.

FIG. 4 is a schematic perspective view illustrating a discharge nozzle.

FIG. 5 is a cross-section illustrating a discharge nozzle, taken on line 5-5 of FIG. 4.

FIG. 6 is an enlarged schematic cross-section of one side of FIG. 3.

FIG. 7 is an enlarged schematic cross-section of the other side of FIG. 3.

FIG. 8 is a schematic perspective view illustrating suction nozzles.

FIG. 9 is a schematic perspective view illustrating a suction nozzle of a first modified example.

FIG. 10 is a schematic perspective view illustrating a suction nozzle of a second modified example.

FIG. 11 is an enlarged schematic cross-section illustrating the other side of FIG. 3 in the second modified example.

FIG. 12 is a schematic cross-section illustrating a flow of liquid metal for hot dipping in an exemplary embodiment.

FIG. 13 is a schematic cross-section illustrating a flow of liquid metal for hot dipping in the second modified example.

FIG. 14 is a schematic cross-section illustrating a flow of liquid metal for hot dipping in a third modified example.

FIG. 15 is a schematic perspective view illustrating a suction nozzle of a fourth modified example.

FIG. 16 is an enlarged schematic cross-section illustrating the other side of FIG. 3 in the fourth modified example.

FIG. 17 is a diagram illustrating a flow of scum in a first comparative example provided with a discharge section lacking a flow regulating function at one width direction side of a steel strip, and provided with a suction section on the other width direction side.

FIG. 18 is a diagram illustrating a flow of scum in a second comparative example employing a discharge nozzle including a flow regulating function.

FIG. 19 is a diagram illustrating a flow of scum in an Example including a suction section at two locations.

FIG. 20 is an enlarged schematic cross-section of part of FIG. 1, as viewed from the side of a hot-dip plating bath surface inside a snout.

FIG. 21 is a graph illustrating a flow speed at the vicinity of a snout inner face with respect to a separation distance SR1 at one side according to water modeling tests.

FIG. 22 is a table of test results.

### DESCRIPTION OF EMBODIMENTS

Explanation follows of exemplary embodiments, with reference to the drawings.

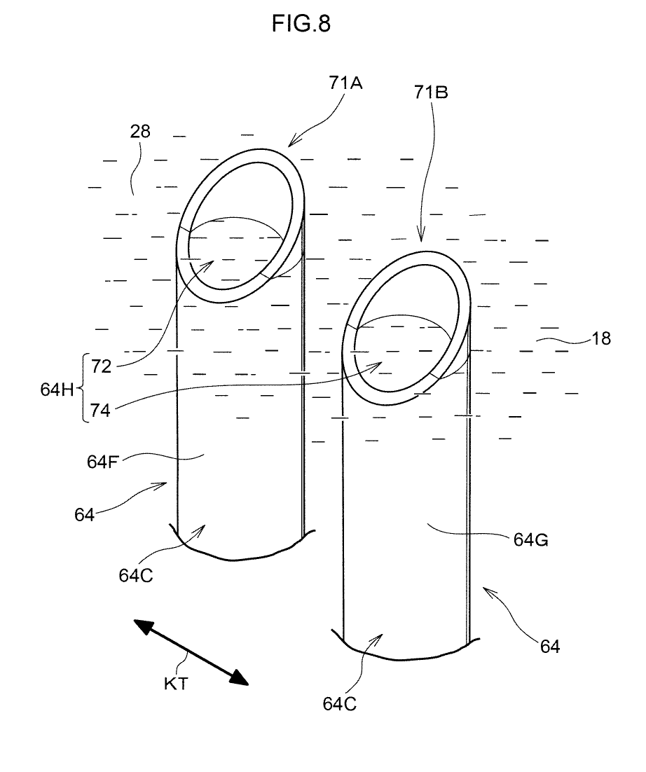

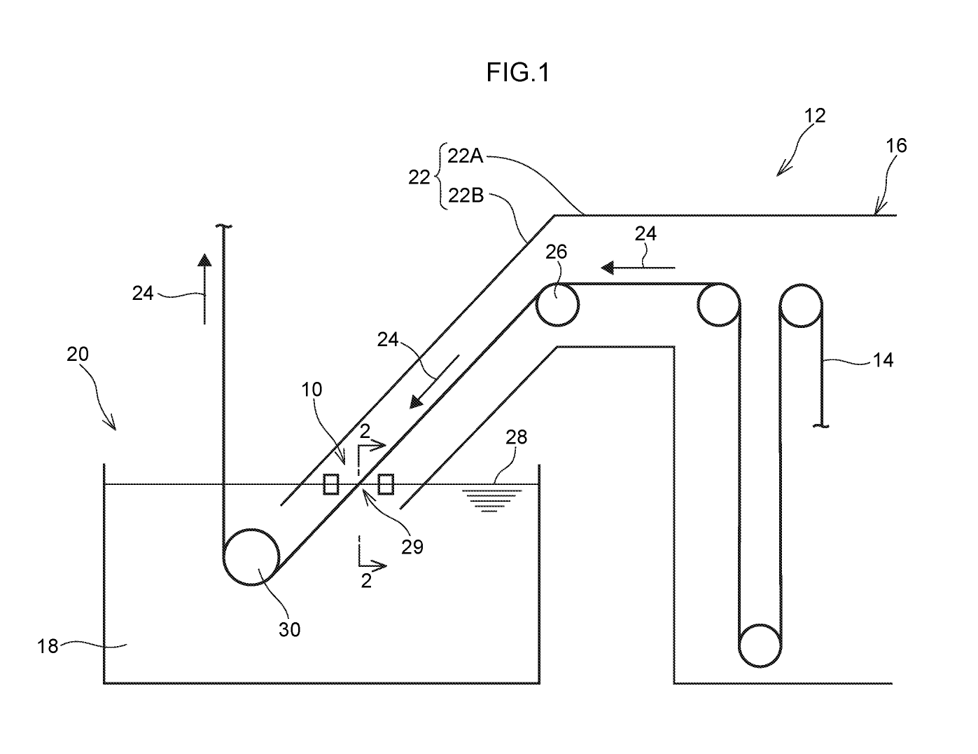

FIG. 1 illustrates an example of a schematic configuration of plating equipment 12 provided with one mode of a scum removal device 10 and a scum removal method according to the present exemplary embodiment. The plating equipment 12 is equipment to plate a steel strip 14 having a thickness of from 1 mm to 3 mm, for example. The plating equipment 12 includes a continuous reduction annealing furnace 16 to anneal the steel strip 14, and a hot-dip plating pot 20 storing a liquid metal for hot dipping 18.

A description will now be given of an example in which molten zinc is employed as the liquid metal for hot dipping 18 and the steel strip 14 is galvanized by immersion, however, there is no limitation thereto. For example, the steel strip 14 can be tinned by employing molten tin, or the steel strip 14 can be aluminum plated by employing molten aluminum.

A snout 22 extends from the reduction annealing furnace 16. The snout 22 includes an extension section 22A extending in a horizontal direction from the reduction annealing furnace 16, and an inclined section 22B extending from the extension section 22A diagonally downward toward the hot-dip plating pot 20. The snout 22 is formed in a rectangular tube shape surrounding the steel strip 14. The leading end portion of the snout 22 is inserted into the liquid metal for hot dipping 18 in the hot-dip plating pot 20.

The internal space of the snout 22 is thereby isolated from the exterior, such that the snout 22 configures a pipeline connecting the reduction annealing furnace 16 and the hot-dip plating pot 20 together in an airtight manner.

The internal space of the snout 22 is filled with a reducing gas to suppress oxidation etc. of the steel strip 14, and the steel strip 14 is immersed in the liquid metal for hot dipping 18 in the hot-dip plating pot 20 without coming into contact with air.

A feed roll 26 is provided at the base end side of the inclined section 22B of the snout 22, to change a conveyance direction 24 of the steel strip 14 diagonally downward. The steel strip 14 that has been annealed in the reduction annealing furnace 16 is conveyed with its length direction along the snout 22, and drawn into a hot-dip plating bath surface 28 inside the snout 22.

The conveyance path of the steel strip 14 inside the snout 22 is determined by the feed roll 26 and a guide roll 30 disposed inside the hot-dip plating pot 20, thereby stabilizing the position of entry of the steel strip 14 into the hot-dip plating bath surface 28 of the liquid metal for hot dipping 18. The conveyance direction 24 of the steel strip 14 is then changed upward by the guide roll 30, and the steel strip 14 is fed out from the hot-dip plating pot 20 to a subsequent process.

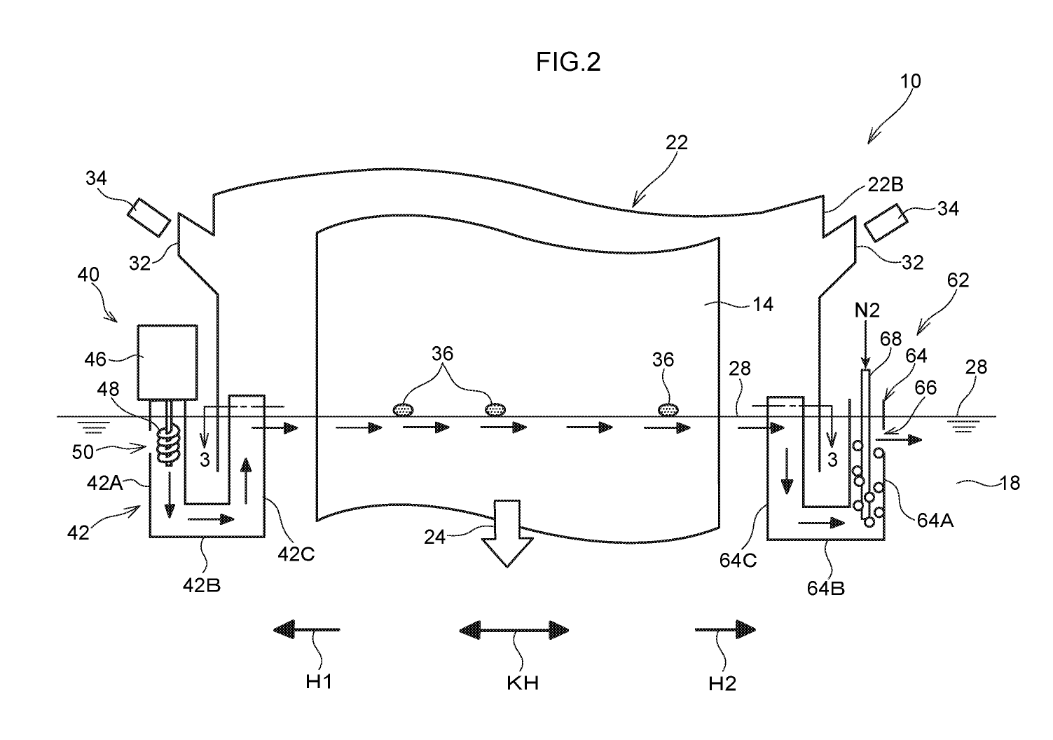

FIG. 2 is a schematic cross-section illustrating in outline a state inside the snout 22, as viewed along line 2-2 of FIG. 1. Observation windows 32 are provided at the two sides of the inclined section 22B of the snout 22 in a steel strip width direction KH. The steel strip width direction KH is a direction orthogonal to the conveyance direction 24 of the steel strip 14.

Cameras 34 are provided at the observation windows 32. The cameras 34 image the way in which the steel strip 14 is drawn into the hot-dip plating bath surface 28 at a steel strip entry position 29.

The steel strip entry position 29 is a position at the intersection of the steel strip 14 and the hot-dip plating bath surface 28, or is a position where the steel strip 14 and the hot-dip plating bath surface 28 are due to intersect, and forms a straight line with length along the steel strip width direction KH in plan view.

Zinc that vaporizes from the liquid metal for hot dipping 18 in a plating process condenses and adheres to the inner face of the snout 22. Any part of the adhered zinc falling, for example due to vibration caused by oscillation of the bath surface, becomes scum 36 floating on the hot-dip plating bath surface 28.

The scum 36 adheres to the steel strip 14 and is a cause of surface defects. The scum removal device 10, described in detail below, is accordingly provided inside the snout 22 to suppress quality defects caused by the scum 36.

Scum Removal Device

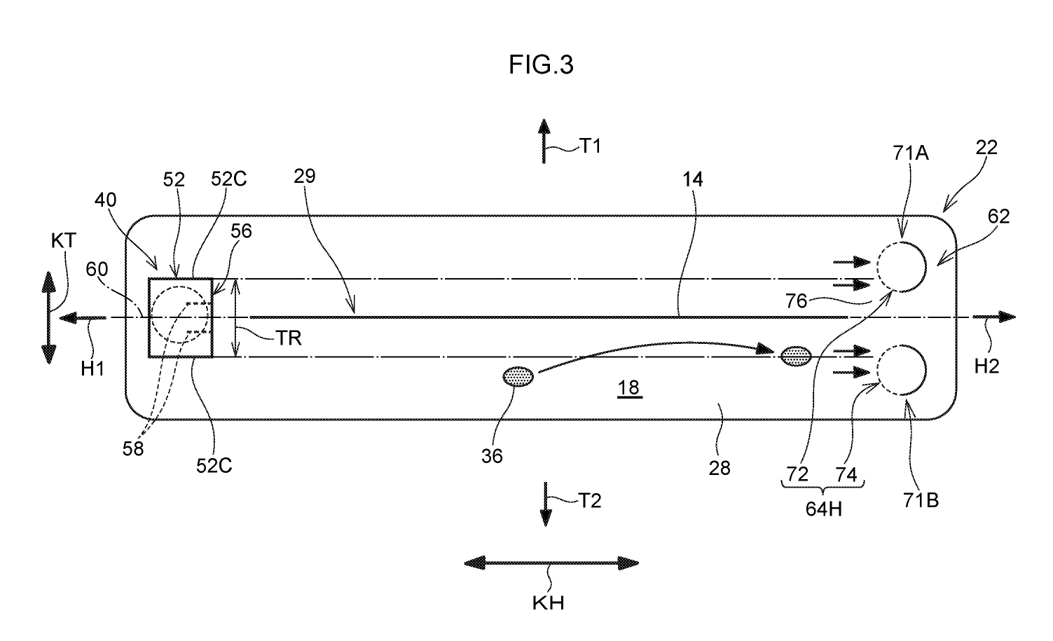

FIG. 3 is an outline cross-section illustrating a state of the hot-dip plating bath surface 28 inside the snout 22 as viewed from above (a horizontal section of the snout 22 and the steel strip 14). The steel strip 14 moves in a direction away from the viewer and into the page in FIG. 3.

The reference numeral 60 indicates an extension line of the steel strip entry position 29, and the extension line 60 is a straight line passing through a thickness direction center of the steel strip 14, and is a hypothetical straight line extension of the steel strip width direction KH. The extension line 60 is at a position substantially equidistant from one inner wall face 22D and another inner wall face 22E.

As illustrated in FIG. 2 and FIG. 3, a discharge device 40 is provided on the extension line 60 of the steel strip 14 at one width direction side H1 of the steel strip 14 (the left side in the drawings).

Discharge Device 40

The discharge device 40 includes a circular tube shaped discharge pipe 42, bent into a U-shaped profile. The discharge pipe 42 includes a vertical outside pipe section 42A disposed outside the snout 22 and extending in a vertical direction, and a communication section 42B extending from a lower end portion of the vertical outside pipe section 42A toward the inside of the snout 22. The discharge pipe 42 includes a vertical inside pipe section 42C extending upward from the leading end of the communication section 42B and disposed at the inside of the snout 22.

The base end portion of the vertical outside pipe section 42A of the discharge pipe 42 extends above the hot-dip plating bath surface 28. A motor 46 is provided at the base end of the vertical outside pipe section 42A. A screw 48 is provided on the drive shaft of the motor 46, and the screw 48 is rotationally driven inside the liquid metal for hot dipping 18.

An intake port 50 is formed to the vertical outside pipe section 42A on the opposite side to the snout 22 at a height position corresponding to the screw 48. The liquid metal for hot dipping 18 that is thereby taken into the vertical outside pipe section 42A, through the intake port 50 open to the outside of the snout 22, is fed under pressure by the rotating screw 48 toward the communication section 42B and toward the vertical inside pipe section 42C.

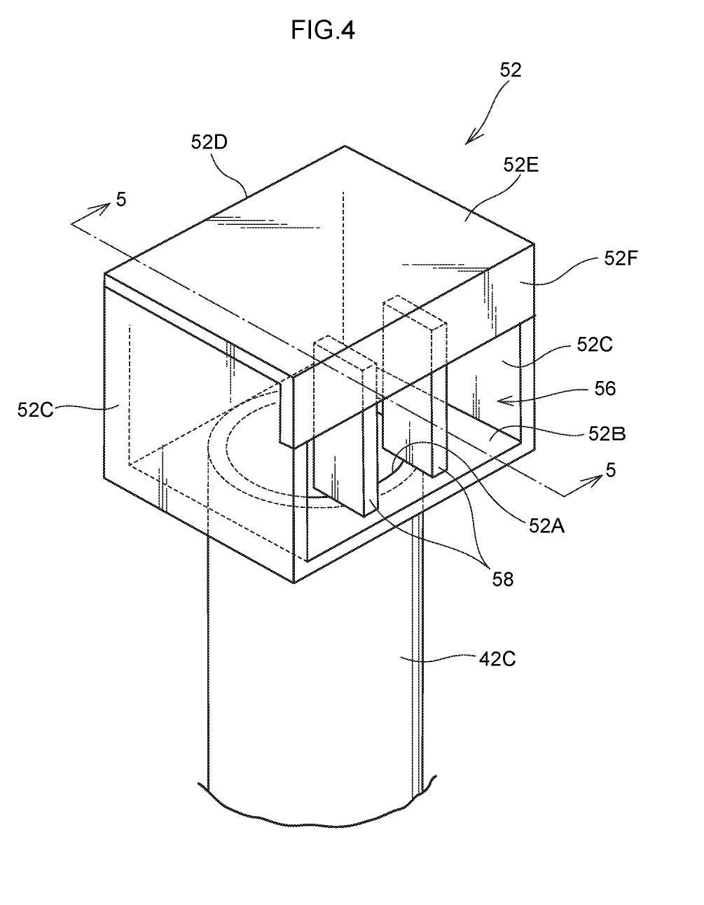

As illustrated in FIG. 4, a cuboid shaped discharge nozzle 52 is provided at a leading end portion of the vertical inside pipe section 42C to discharge the liquid metal for hot dipping 18 at the hot-dip plating bath surface 28 inside the snout 22. A description follows of the discharge nozzle 52, taking the direction the liquid metal for hot dipping 18 is discharged in toward the steel strip 14 side, as described later, as being the front of the discharge nozzle 52.

Discharge Nozzle 52

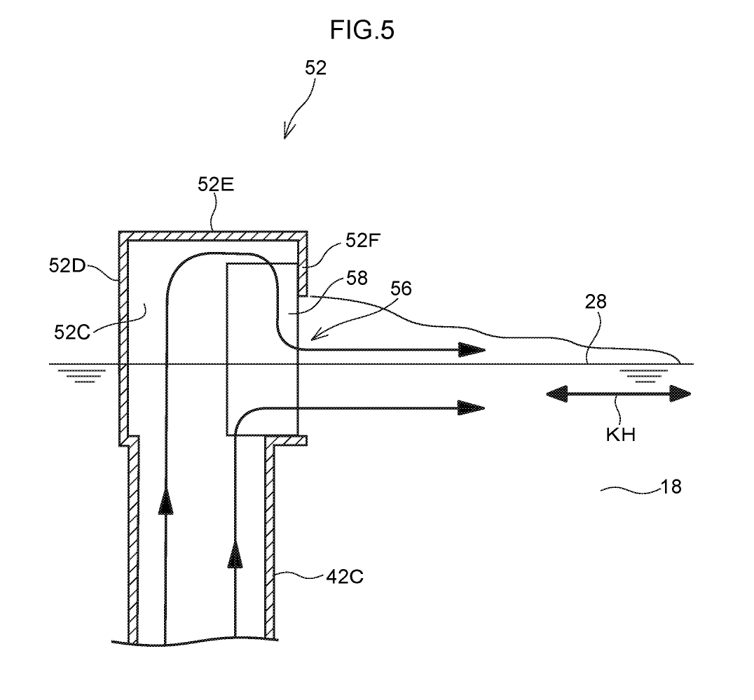

The discharge nozzle 52 includes a bottom plate 52B formed with a circular hole 52A in communication with the vertical inside pipe section 42C, and side walls 52C extending upward at two side edges of the bottom plate 52B. The discharge nozzle 52 also includes a rear wall 52D extending upward at a rear edge of the bottom plate 52B, and a top plate 52E provided so as to be contiguous to upper edges of the side walls 52C and the rear wall 52D. An extension plate 52F extends from a front edge of the top plate 52E toward the bottom plate 52B side. A discharge section 56 is formed between the extension plate 52F and the bottom plate 52B, opening onto the steel strip 14 side. As illustrated in FIG. 5, the extension plate 52F suppresses ripples from being formed in the liquid metal for hot dipping 18 as it is discharged from the discharge section 56.

As illustrated in FIG. 4, a pair of flow regulation plates 58 are installed upright on the bottom plate 52B. As illustrated in FIG. 5, the flow regulation plates 58 are formed in rectangular shapes, and are sufficiently tall for upper portions of the flow regulation plates 58 to be supported by the extension plate 52F. The discharge nozzle 52 is disposed such that a lower side of the discharge nozzle 52 is at a position in the liquid metal for hot dipping 18.

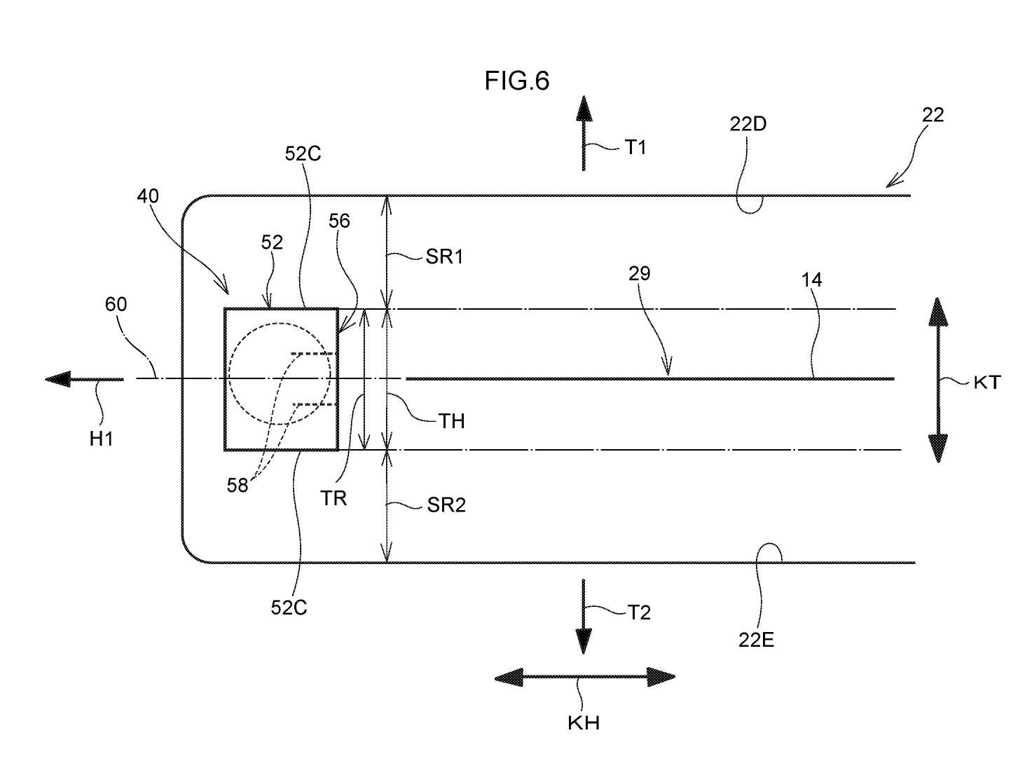

The flow of the liquid metal for hot dipping 18 discharged from the discharge section 56 is regulated with enhanced straight line directionality along the steel strip width direction KH by the flow regulation plates 58 and the side walls 52C, as illustrated in FIG. 3 and FIG. 6. Moreover, due to the flow of the discharged liquid metal for hot dipping 18 being regulated by the flow regulation plates 58 and the side walls 52C, the flow speed (the steel strip width direction KH component) of the liquid metal for hot dipping 18 in the vicinity of the steel strip 14 is raised in comparison to cases lacking flow regulation, and the scum 36 is quickly washed away.

The discharge section 56 is disposed on the extension line 60 from the steel strip 14 extending along the steel strip width direction KH, with approximately the width direction center of the discharge section 56 positioned on the extension line 60 of the steel strip 14. Thus, the discharge device 40 discharges the liquid metal for hot dipping 18, taken in through the intake port 50 at the outside of the snout 22, through the discharge section 56 from the one width direction side H1 of the steel strip 14, toward the steel strip 14 side, such that the liquid metal for hot dipping 18 flows along the hot-dip plating bath surface 28.

Suction Device 62

Moreover, as illustrated in FIG. 2, a suction device 62 is provided at another width direction side H2 of the steel strip 14 (the right side in the drawing). The suction device 62 includes a circular tube shaped suction pipe 64 bent into a U-shaped profile. The suction pipe 64 includes a vertical outside pipe 64A disposed outside the snout 22 and extending in a vertical direction, and a communication section 64B extending toward the snout 22 inside from a lower end portion of the vertical outside pipe 64A. The suction pipe 64 also includes a vertical inside pipe 64C disposed inside the snout 22 and extending upward from the leading end of the communication section 64B.

The base end portion of the vertical outside pipe 64A of the suction pipe 64 is disposed so as to extend above the hot-dip plating bath surface 28. An exhaust port 66 is opened in the base end portion of the vertical outside pipe 64A on the opposite to the snout 22, at a height position in the liquid metal for hot dipping 18.

A gas supply pipe 68 is inserted into a base end opening of the vertical outside pipe 64A to supply nitrogen gas (N₂) fed from a supply source, not illustrated in the drawings. The leading end of the gas supply pipe 68 reaches a lower portion of the vertical outside pipe 64A. The liquid metal for hot dipping 18 is exhausted through the exhaust port 66 by the nitrogen gas being supplied through the gas supply pipe 68, thereby lowering the internal pressure inside the vertical outside pipe 64A. The liquid metal for hot dipping 18 inside the vertical inside pipe 64C flows into the vertical outside pipe 64A through the communication section 64B due to the lowered internal pressure.

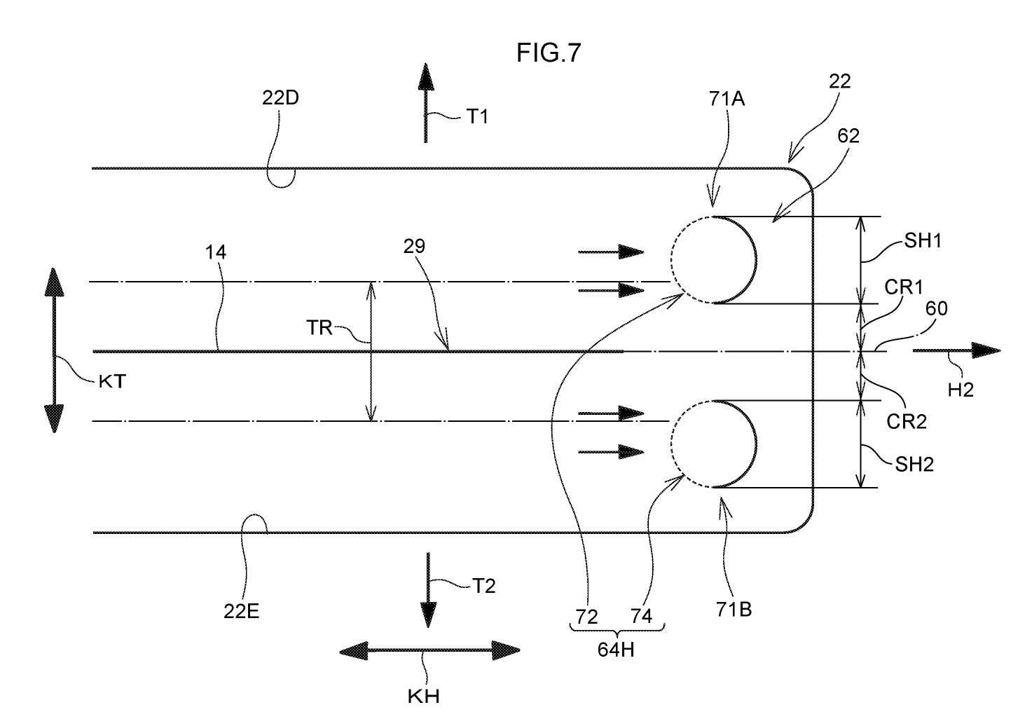

A first suction nozzle 71A and a second suction nozzle 71B, as illustrated in FIG. 3 and FIG. 7 are thereby configured at an end portion of the vertical inside pipe 64C. A first suction portion 72 and a second suction portion 74 are configured by respective openings of the first suction nozzle 71A and the second suction nozzle 71B. A suction section 64H (see FIG. 3) to suck in the liquid metal for hot dipping 18 is configured by the first suction portion 72 and the second suction portion 74.

Reference here to a suction section (the first suction portion 72 and the second suction portion 74) indicates openings where nozzles (the first suction nozzle 71A and the second suction nozzle 71B) are provided to suck in the liquid metal for hot dipping 18.

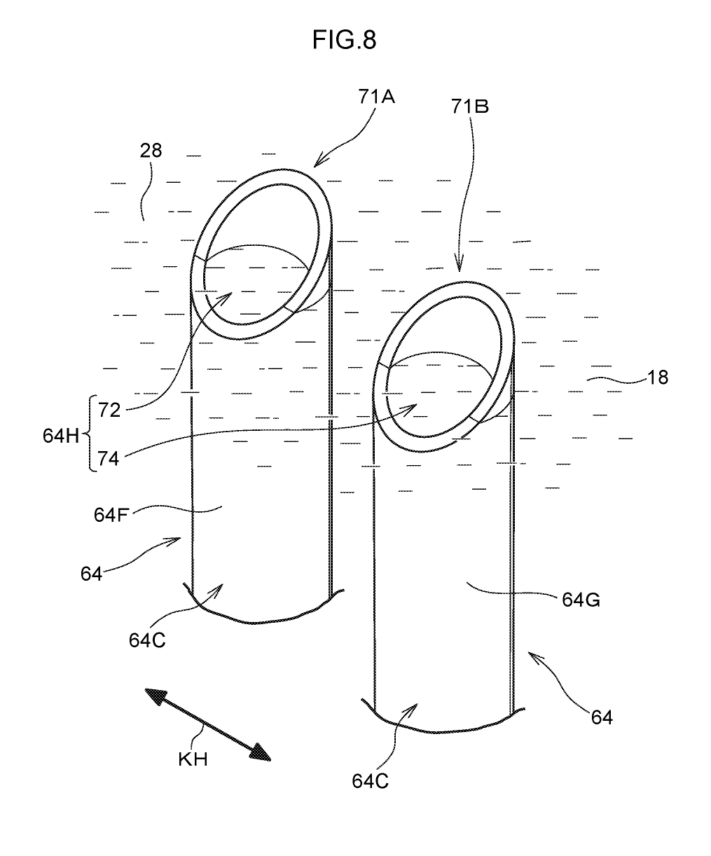

The first suction nozzle 71A and the second suction nozzle 71B may, for example, be configured by the respective suction pipes 64 of a pair of the suction devices 62. As illustrated in FIG. 8, the suction pipes 64 are each provided along the up-down direction so as to be separated from each other in a steel strip thickness direction KT (see FIG. 7). A first pipe 64F is configured at an upper end portion of the vertical inside pipe 64C of one of the suction pipes 64. Moreover, a second pipe 64G is configured at an upper end portion of the vertical inside pipe 64C of the other of the suction pipes 64.

The leading end portion of the first pipe 64F is cut at an inclination on the steel strip entry position 29 side thereof (see FIG. 7). The plane of the opening is inclined so as to open toward the steel strip entry position 29 side at the hot-dip plating bath surface 28. Namely, the plane of the opening at the leading end portion of the first pipe 64F intersects at an angle with the hot-dip plating bath surface 28. The leading end portion of the first pipe 64F accordingly configures the first suction nozzle 71A including the first suction portion 72 to suck in the liquid metal for hot dipping 18.

A leading end portion of the second pipe 64G is also cut at an inclination on the steel strip entry position 29 side thereof (see FIG. 7). The plane of the opening is inclined so as to open toward the steel strip entry position 29 side at the hot-dip plating bath surface 28. Namely, the plane of the opening at the leading end portion of the second pipe 64G intersects at an angle with the hot-dip plating bath surface 28. The leading end portion of the second pipe 64G accordingly configures the second suction nozzle 71B including the second suction portion 74 to suck in the liquid metal for hot dipping 18.

The suction section 64H is thereby configured by the first suction portion 72 and the second suction portion 74, to suck in the scum 36 (see FIG. 3) floating on the liquid metal for hot dipping 18, together with the liquid metal for hot dipping 18, so as to remove the scum 36.

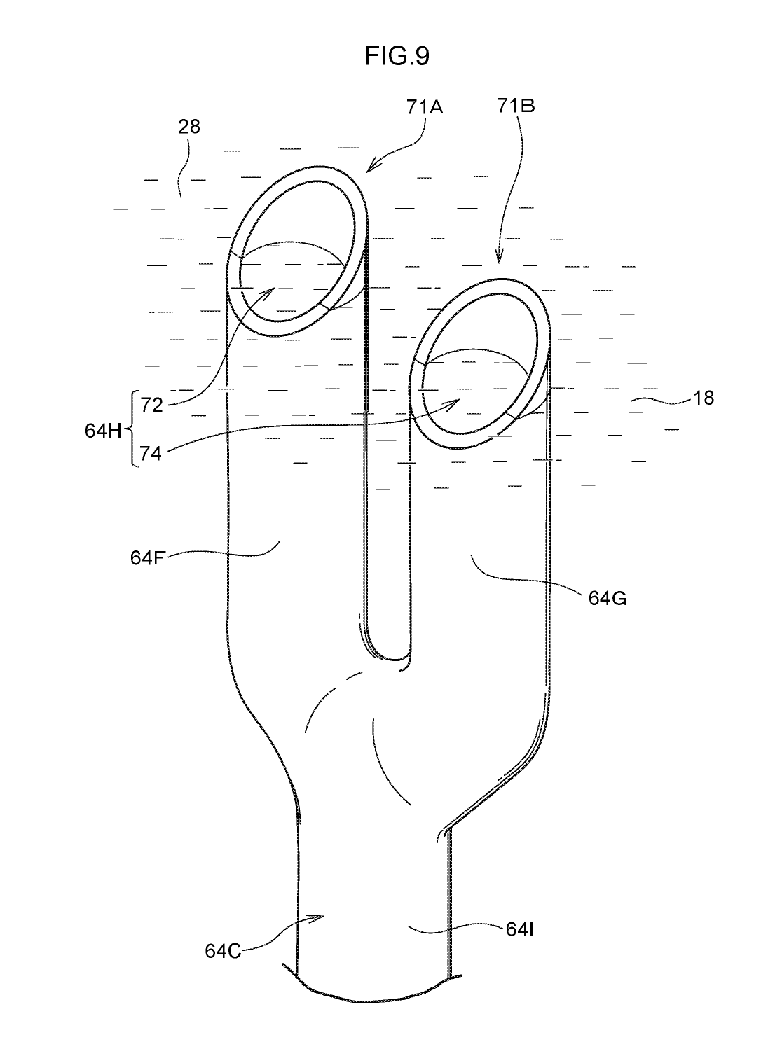

As illustrated in FIG. 9, the first pipe 64F and the second pipe 64G may also be configured as bifurcations branching from a main pipe 641 provided in the liquid metal for hot dipping 18 (a first modified example). The configuration of the suction device 62 can be simplified in this case by configuring the main pipe 641 at the end portion of the vertical inside pipe 64C.

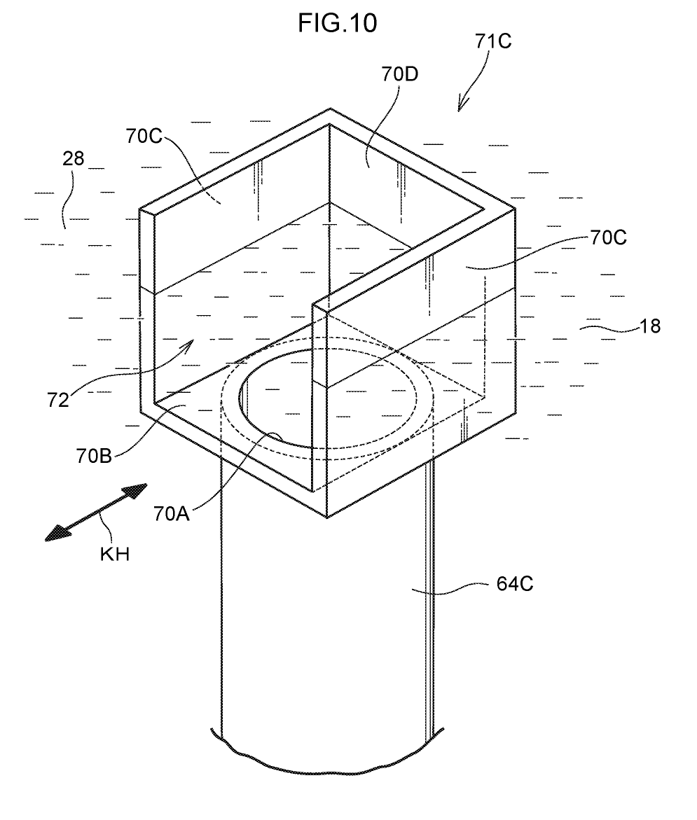

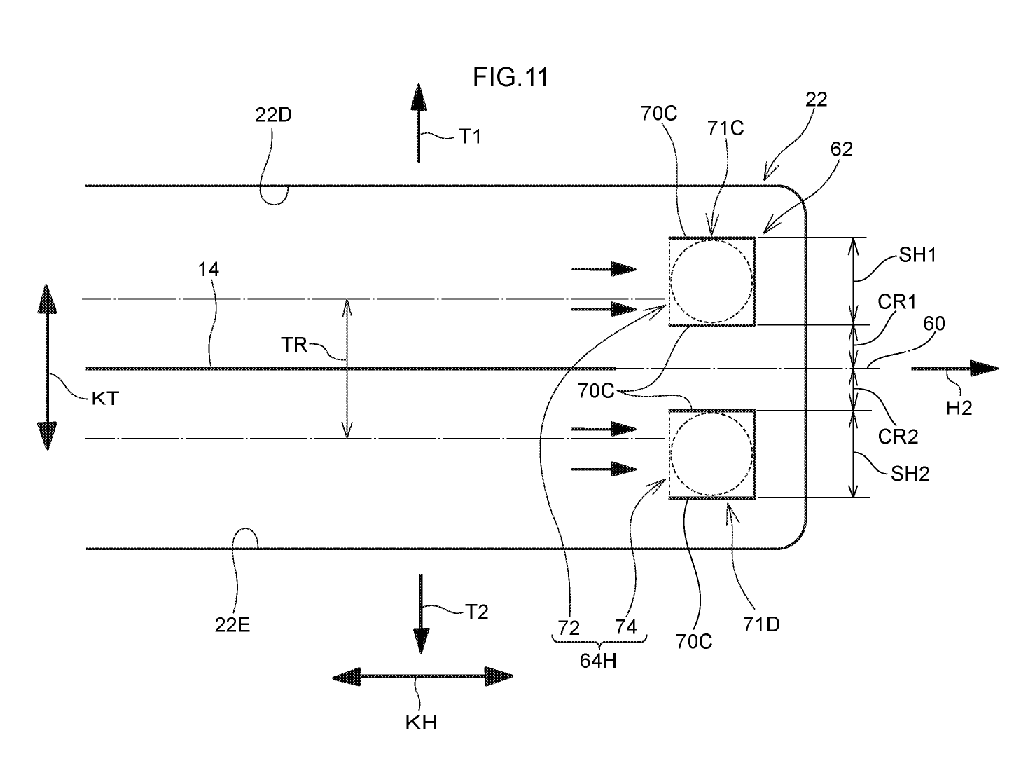

Moreover, configurations of the suction nozzles 71A, 71B are not limited to the profiles given above. An example of a second modified example is illustrated in FIG. 10 (in which only a first suction nozzle 71C is illustrated) and FIG. 11. Note that the same or equivalent portions to those of FIG. 3 and FIG. 7 are appended with the same reference numerals in FIG. 11, and duplicate description is omitted thereof.

Namely, the first suction nozzle 71C is provided at the leading end portion of the vertical inside pipe 64C. Taking the open direction of the first suction portion 72 as being the front of the first suction nozzle 71C, the first suction nozzle 71C includes a bottom plate 70B including a circular hole 70A in communication with the vertical inside pipe 64C, and side walls 70C extending upward from the two side edges of the bottom plate 70B. Moreover, the first suction nozzle 71C includes a rear wall 70D provided extending upward from a rear edge of the bottom plate 70B, with edges of the rear wall 70D contiguous to the side walls 70C.

The side walls 70C configure flow regulation plates that function to regulate flow of the sucked in liquid metal for hot dipping 18 along the steel strip width direction KH. Note that a second suction nozzle 71D is also configured in a similar manner to the first suction nozzle 71C.

Due to the presence of the side walls 70C, as illustrated in FIG. 11, an opening width SH1 of the first suction nozzle 71C (an opening width SH2 of the second suction nozzle 71D) is fixed, and does not depend on the height of the hot-dip plating bath surface 28.

A description now follows regarding a flow regulating function of the flow regulation plates configured by the side walls 70C.

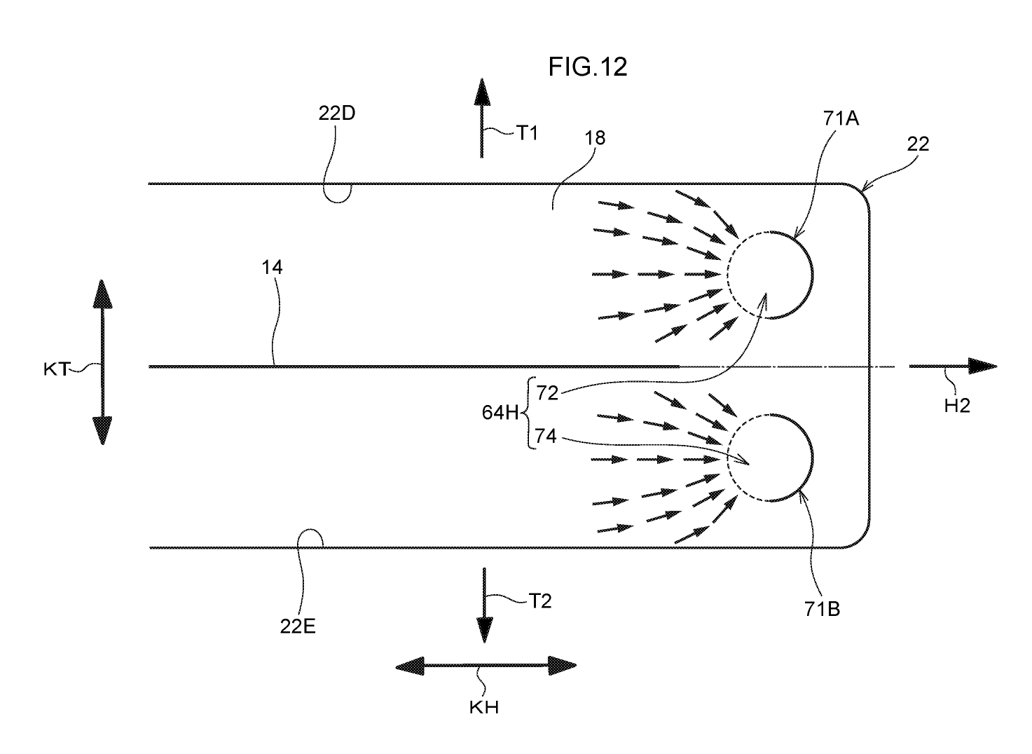

As illustrated in FIG. 12, when the suction nozzles 71A, 71B lack side walls, the liquid metal for hot dipping 18 surrounding each of suction portions 72, 74 at the center is sucked in. This accordingly allows flows to be generated at the vicinity of inner wall faces 22D, 22E in the liquid metal for hot dipping 18 in the snout 22.

There is accordingly a need to adjust an amount of the liquid metal for hot dipping 18 sucked in at the suction portions 72, 74 so that scum adhered to the inner wall faces 22D, 22E is not dislodged by the flow of the liquid metal for hot dipping 18 generated in the vicinity of the inner wall faces 22D, 22E.

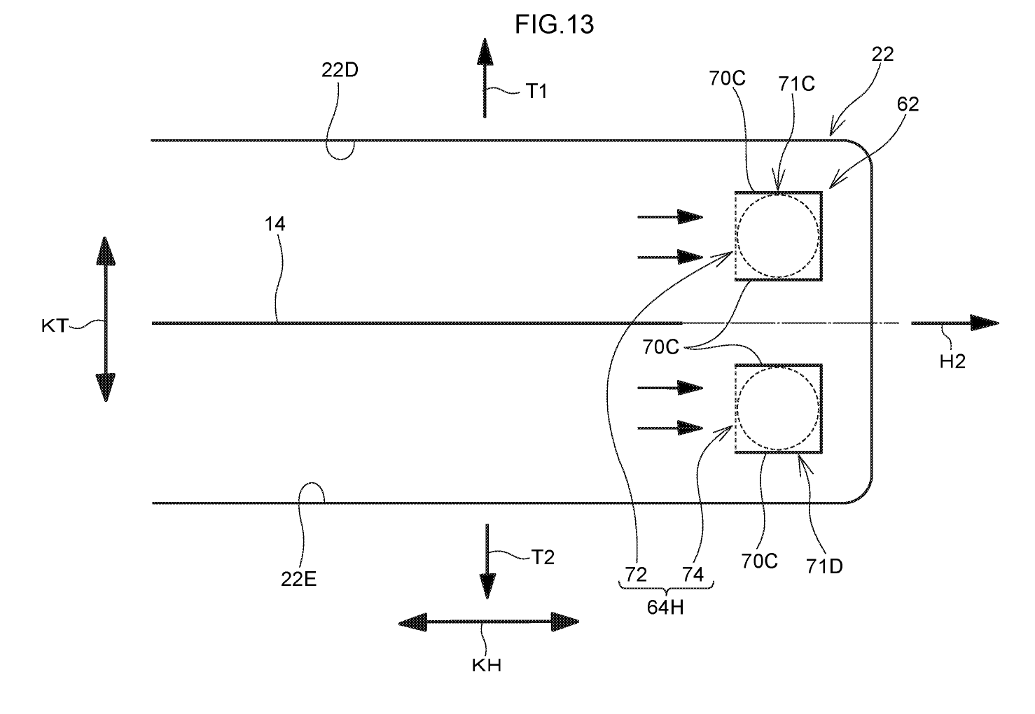

Thus, as illustrated in FIG. 13, the suction nozzles 71C, 71D equipped with flow regulating function by the side walls 70C are employed so as to enable the sucking-in direction to be aligned with the steel strip width direction KH.

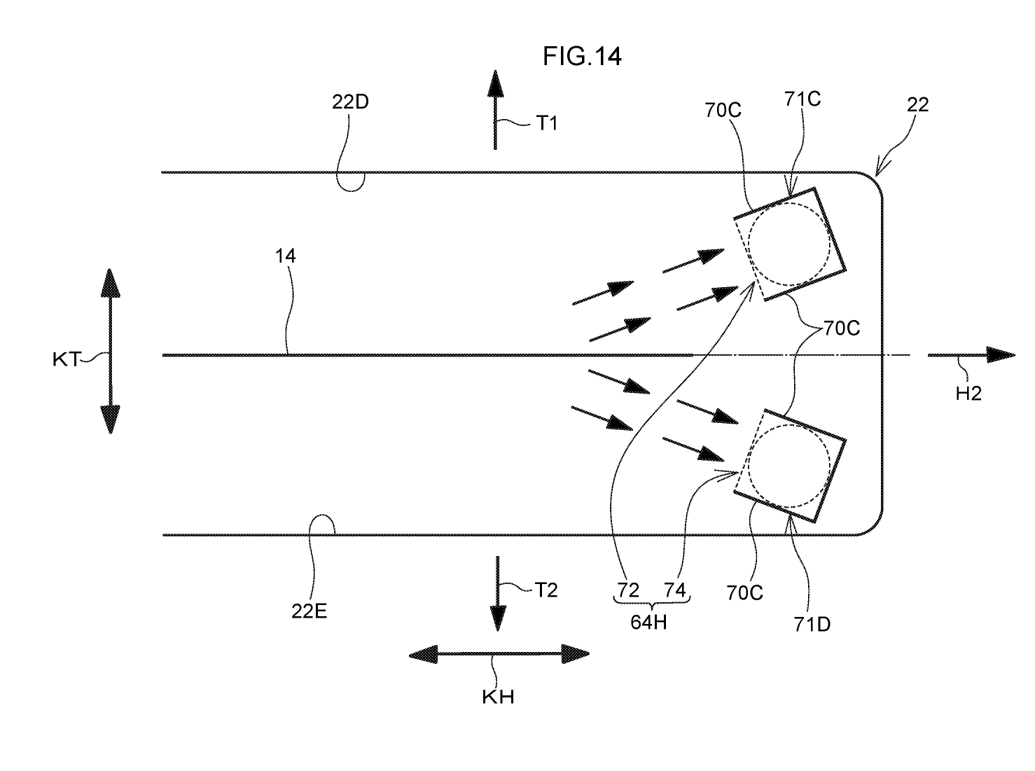

When doing so, as illustrated in FIG. 14, the flow of liquid metal for hot dipping 18 in the vicinity of the inner wall faces 22D, 22E is suppressed by disposing the two suction nozzles 71C, 71D angled such that each of the suction portions 72, 74 faces the steel strip 14 side for cases in which the two suction nozzles 71C, 71D are disposed separated from each other.

As illustrated in FIG. 7 and FIG. 11, the first suction nozzle 71A or 71C and the second suction nozzle 71B or 71D are disposed such that the approximate center between the pairs of suction nozzles 71A, 71B, 71C, 71D is positioned on the extension line 60 of the steel strip 14.

As a result, the first suction portion 72 of the first suction nozzle 71A or 71C is disposed on one thickness direction side T1 of the steel strip 14 about a boundary at the extension line 60 of the steel strip 14, and sucks in the liquid metal for hot dipping 18 at the hot-dip plating bath surface 28 on the one thickness direction side T1 of the extension line 60 of the steel strip 14. Moreover, the second suction portion 74 of the second suction nozzle 71B or 71D is disposed on the other thickness direction side T2 about a boundary at the extension line 60 of the steel strip 14, and sucks in the liquid metal for hot dipping 18 at the hot-dip plating bath surface 28 on the other thickness direction side T2 of the extension line 60 of the steel strip 14.

The positional relationship between the snout 22, the discharge section 56, and each of the suction portions 72, 74 in the scum removal device 10 will now be described with reference to FIG. 6, FIG. 7, and FIG. 11.

FIG. 6 is a diagram indicating the one width direction side H1 of the snout 22. The discharge section 56 formed by the discharge nozzle 52 of the discharge device 40 is disposed such that the width direction center of the discharge section 56 in the steel strip thickness direction KT is substantially aligned with the extension line 60 of the steel strip 14, and an opening width TH of the discharge section 56 in the steel strip thickness direction KT is set to no less than 50 mm. A discharge region TR of the discharge section 56 is determined by the opening width TH and the placement of the discharge section 56.

The discharge section 56 is also disposed so as to be separated by no less than 100 mm from the inner faces of the snout 22 facing the steel strip 14 on entry at the steel strip entry position 29. Namely, a separation distance SR1 from one end of the discharge section 56 to the one inner wall face 22D of the snout 22 is no less than 100 mm. Moreover, a separation distance SR2 from the other end of the discharge section 56 to the other inner wall face 22E of the snout 22 is no less than 100 mm, and the separation distance SR1 and the separation distance SR2 are set so as to be substantially the same dimensions as each other.

FIG. 7 and FIG. 11 are diagrams illustrating the other width direction side H2 of the snout 22. The steel strip thickness direction KT center between the first suction nozzle 71A, 71C and the second suction nozzle 71B, 71D of the suction device 62 is disposed so as to be substantially aligned with the extension line 60 of the steel strip 14.

The first suction nozzle 71A, 71C is set to adjust the amount projecting out from the hot-dip plating bath surface 28. The opening width SH1 of the first suction portion 72 of the first suction nozzle 71A, 71C is thereby no less than 40 mm at the height position of the hot-dip plating bath surface 28. Moreover, a separation distance CR1 from an edge of the first suction nozzle 71A, 71C on the side of the extension line 60 of the steel strip 14 to the extension line 60 is no less than 30 mm. Note that due to the first suction nozzle 71C including the side walls 70C, as described above, the opening width SH1 and the separation distance CR1 are fixed, and do not depend on the height of the hot-dip plating bath surface 28.

The second suction nozzle 71B, 71D is set to adjust the amount thereof projecting out from the hot-dip plating bath surface 28. The opening width SH2 of the second suction portion 74 of the second suction nozzle 71B, 71D is thereby no less than 40 mm. Moreover, a separation distance CR2 from an edge of the second suction nozzle 71B, 71D on the side of the extension line 60 the steel strip 14 to the extension line 60 is no less than 30 mm. Note that due to the second suction nozzle 71D including the side walls 70C, as described above, the opening width SH2 and the separation distance CR2 are fixed, and do not depend on the height of the hot-dip plating bath surface 28. The respective suction nozzles 71A to 71D of the present exemplary embodiment are provided at positions with approximate line symmetry about the extension line 60.

The center of the first suction portion 72 is positioned at the one thickness direction side T1 of the end of the discharge section 56 on the one thickness direction side T1. Moreover, the center of the second suction portion 74 is positioned at the one thickness direction side T1 of the end of the discharge section 56 on the other thickness direction side T2.

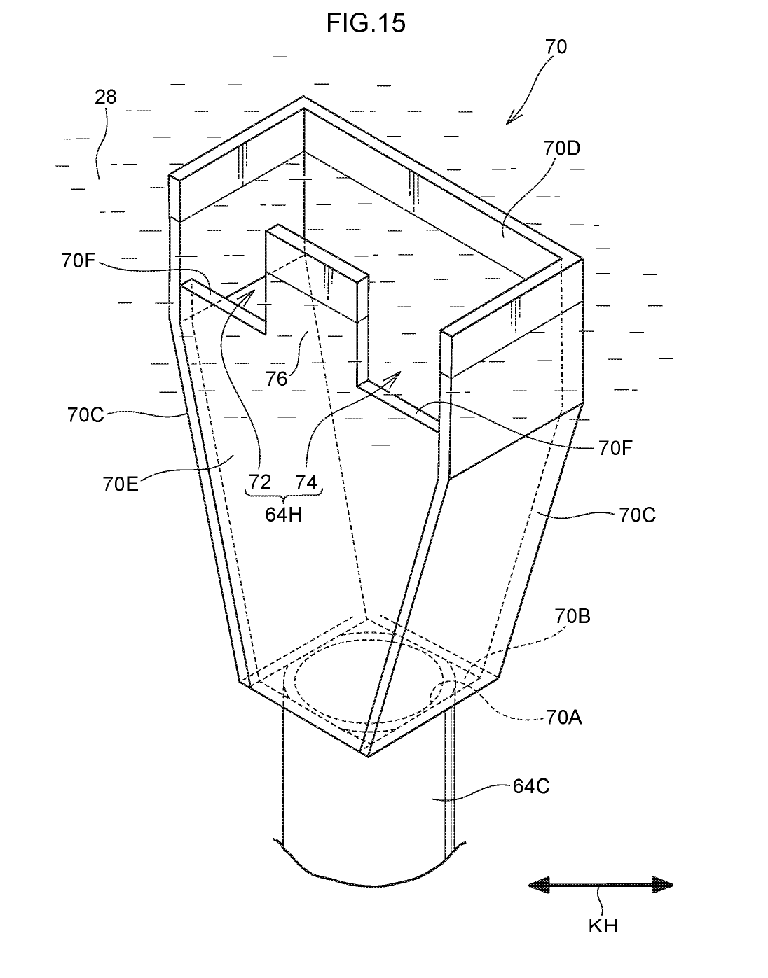

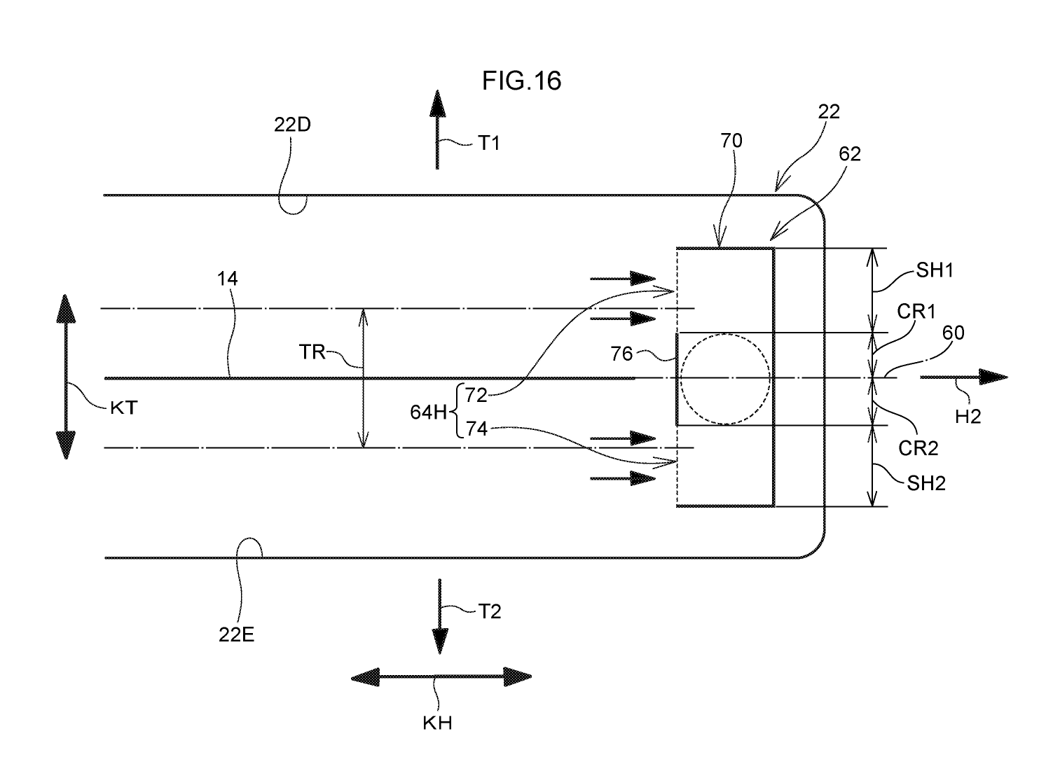

Furthermore, a fourth modified example is illustrated in FIG. 15 and FIG. 16.

Namely, a suction nozzle 70 is provided at a leading end portion of a vertical inside pipe 46C. Taking the open direction of each suction portion 72, 74 as the front of the suction nozzle 70, the suction nozzle 70 includes a bottom plate 70B including a circular hole 70A in communication with the vertical inside pipe 64C, and side walls 70C extending in a diagonally upward direction from the two side edges of the bottom plate 70B, with an upper section of each side wall 70C extending in a vertical direction. Moreover, the suction nozzle 70 includes a rear wall 70D provided extending upward from a rear edge of the bottom plate 70B with edges of the rear wall 70D contiguous to the side walls 70C, and a front wall 70E provided extending upward from a front edge of the bottom plate 70B with edges of the bottom plate 70B contiguous to the side walls 70C, so as to form a box shape open upward.

Rectangular shaped cutouts 70F are formed at the two sides of an upper edge of the front wall 70E. A first suction portion 72 and a second suction portion 74 are formed by the respective cutouts 70F, as examples of a first opening and a second opening open on the steel strip 14 side. A blocking portion 76 is configured at a location between the two suction portions 72, 74 by a remaining portion of the upper section of the front wall 70E.

A lower edge of each of the suction portions 72, 74 is disposed so as to be at a position below the hot-dip plating bath surface 28. Upper edge portions of the side walls 70C and the rear wall 70D, and an upper edge portion of the blocking portion 76 of the front wall 70E, extend to above the hot-dip plating bath surface 28. This enables the scum 36 floating on the liquid metal for hot dipping 18 to be sucked in with the liquid metal for hot dipping 18 through the first suction portion 72 and the second suction portion 74, and to be removed. The liquid metal for hot dipping 18 is obstructed from being sucked in at the blocking portion 76.

As illustrated in FIG. 16, the approximate center of the suction nozzle 70 in the width direction is disposed at a position on the extension line 60 of the steel strip 14. The first suction portion 72 of the suction nozzle 70 is disposed at the one steel strip 14 thickness direction side T1 of the extension line 60 of the steel strip 14, and sucks in the liquid metal for hot dipping 18 on the one thickness direction side T1 of the extension line 60 of the steel strip 14 at the hot-dip plating bath surface 28. Moreover, the second suction portion 74 is disposed at the other thickness direction side T2 of the extension line 60 of the steel strip 14, and sucks in the liquid metal for hot dipping 18 on the other thickness direction side T2 of the extension line 60 of the steel strip 14 at the hot-dip plating bath surface 28.

The suction nozzle 70 is disposed such that the center of the suction nozzle 70 in the width direction, this being the steel strip thickness direction KT, is substantially aligned with the extension line 60 of the steel strip 14. The location of the suction nozzle 70 on the extension line 60 of the steel strip 14 is blocked off by the blocking portion 76.

The opening width SH1 of the first suction portion 72 is no less than 40 mm, and the separation distance CR1 from the edge of the suction nozzle 70 on the width direction center side to the width direction center of the suction nozzle 70 is no less than 30 mm. Moreover, the opening width SH2 of the second suction portion 74 is no less than 40 mm, and the separation distance CR2 from the edge of the suction nozzle 70 on the width direction center side to the width direction center of the suction nozzle 70 is no less than 30 mm. The suction nozzle 70 of the present exemplary embodiment has substantial line symmetry about the width direction center, namely, about the extension line 60.

The center of the first suction portion 72 is positioned at the one thickness direction side T1 of the one thickness direction side T1 end of the discharge section 56. Moreover, the center of the second suction portion 74 is positioned at the other thickness direction side T2 of the other thickness direction side T2 end of the discharge section 56.

Operation of the scum removal device 10 and the scum removal method according to the present exemplary embodiment with the configurations described above will now be described in comparison to related technology.

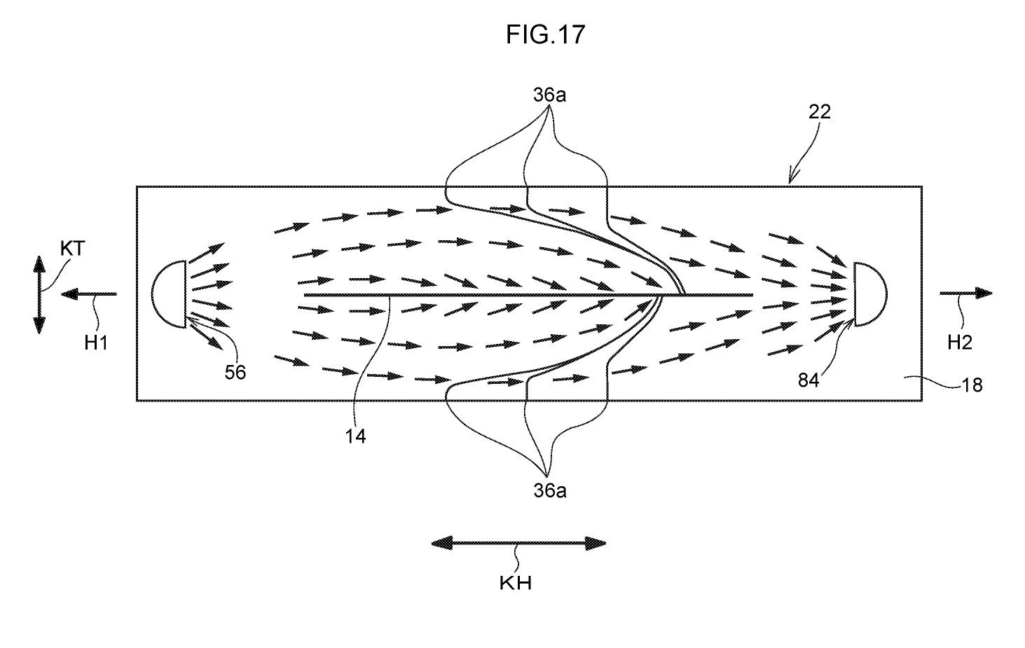

FIG. 17 illustrates a most basic configuration in which a discharge section 56 lacking a function to regulate the flow of discharged liquid metal for hot dipping 18 is provided at one width direction side H1 of a steel strip 14, and a suction section 84 is provided at another width direction side H2 of the steel strip 14 (Comparative Example 1).

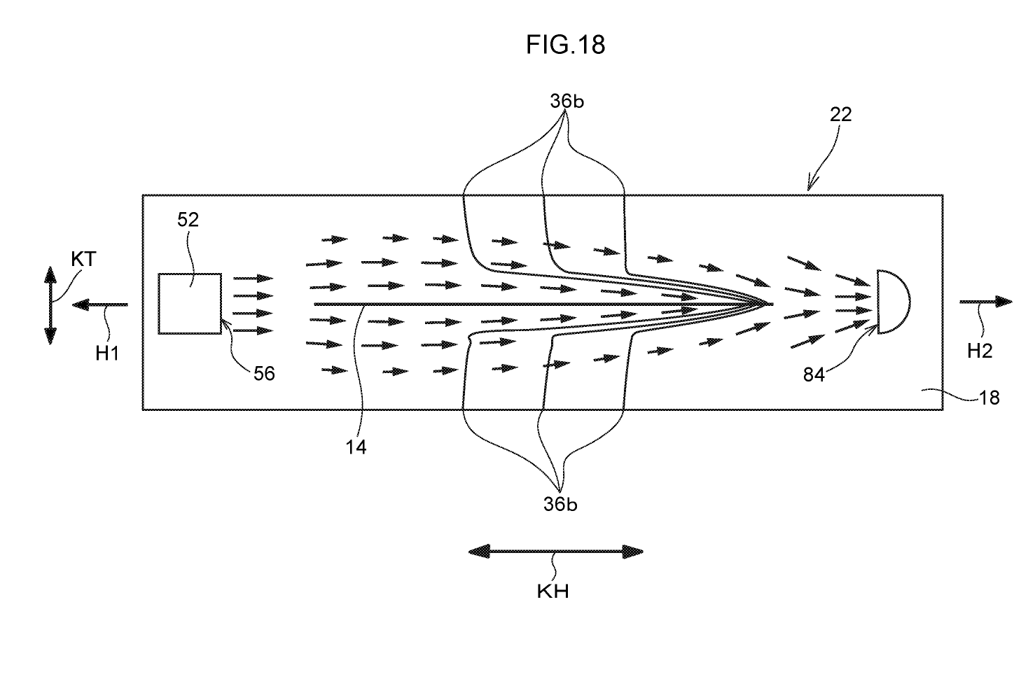

FIG. 18 illustrates a configuration in which a discharge nozzle 52 including a flow regulating function performed by the flow regulation plates 58 and side walls 52C illustrated in FIG. 4 is employed in place of the discharge section 56 of FIG. 17 (Comparative Example 2).

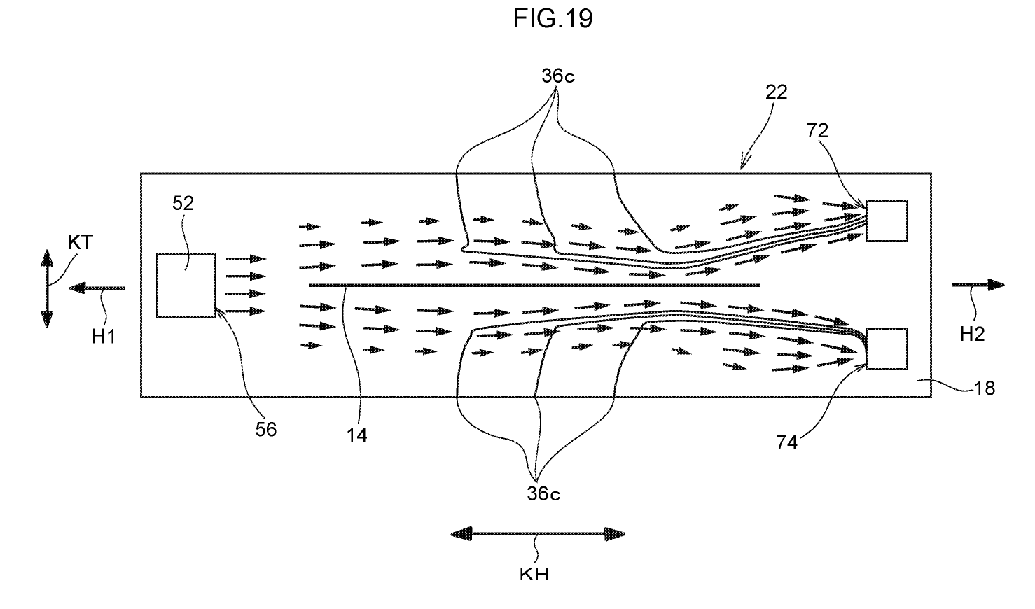

FIG. 19 illustrates an Example of the present exemplary embodiment including the two suction portions 72, 74 instead of the suction section 84 of FIG. 18.

A flow when scum 36a, 36b, 36c adhered to wall faces of a snout 22 has been dislodged from the same positions on respective wall faces will be described for each of these configurations.

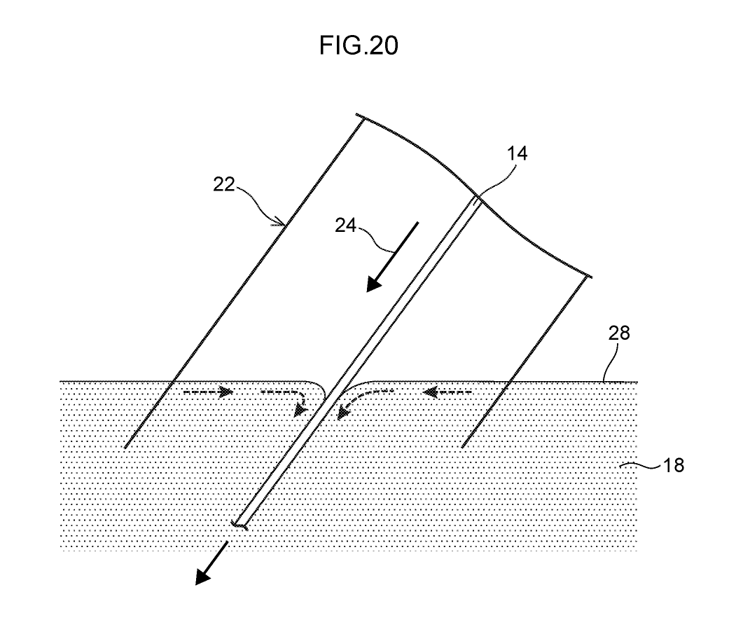

Note that FIG. 20 is a diagram illustrating a state of the hot-dip plating bath surface 28 in the snout 22. An accompanying current is generated at the hot-dip plating bath surface 28 in the snout 22 by the liquid metal for hot dipping 18 being drawn in together with the steel strip 14 being fed in the conveyance direction 24.

In the basic configuration of FIG. 17 (Comparative Example 1), the liquid metal for hot dipping 18 is discharged in a radial pattern in concentric waves from the discharge section 56. Thus in the range where the steel strip 14 is present, an average flow is generated in the snout 22 across the entire range of the snout 22 in the short direction, which is the steel strip thickness direction KT. The flow of the liquid metal for hot dipping 18 accordingly has a comparatively high flow speed at the wall faces of the snout 22. The scum 36a adhered to the wall faces of the snout 22 is accordingly readily dislodged.

Moreover, the flow speed in the steel strip width direction KH in the vicinity of the steel strip 14 is roughly the same as in the vicinity of the wall faces of the snout 22. The flow speed in the steel strip width direction KH is thus not fast enough to cause the scum 36a to flow in a direction away from an end portion in the steel strip width direction KH. The scum 36a is therefore sucked in toward the steel strip 14 by the accompanying current of the liquid metal for hot dipping 18 being drawn in together with the steel strip 14, and adheres to the steel strip 14, resulting in defects.

Due to the discharge section 56 including a flow regulating function being employed in FIG. 18, the flow speed in the steel strip width direction KH in the snout 22 is slower at the vicinity of the wall faces of the snout 22, suppressing the scum 36b from detaching from the wall faces. Moreover, the flow speed in the steel strip width direction KH is high in the vicinity of the steel strip 14, causing the scum 36b to resist the accompanying current and flow in the steel strip width direction KH. The scum 36b can accordingly be suppressed from adhering to the steel strip 14 in comparison to the basic configuration of FIG. 17 (Comparative Example 1).

However, even in this method, the scum 36b sometimes adheres to the steel strip 14 on the suction section 84 side.

Thus, the flow of the hot-dip plating bath surface 28 was observed, and the position of the scum 36b adhered to the steel strip 14 was investigated. From this it was apparent that although a flow substantially in the steel strip width direction KH was generated at a portion slightly away from the steel strip 14 in the steel strip thickness direction KT, a flow toward an end portion of the steel strip 14 was generated at the suction section 84 side.

Thus, as illustrated in FIG. 19, tests were performed with the first suction portion 72 and the second suction portion 74 disposed separated from each other in the steel strip thickness direction KT, as an Example of the exemplary embodiment. This enabled the flow toward the end portion of the steel strip 14 of FIG. 18 to be diverted to a direction away from the steel strip 14 in the steel strip thickness direction KT, and enabled the scum 36c to be sucked into the first suction portion 72 and the second suction portion 74.

Next, preferable placements and operation and advantageous effects of exemplary embodiments of the present invention will be discussed.

Namely, in the scum removal device 10, liquid metal for hot dipping taken in from outside the snout 22 is discharged through the discharge section 56, and to form a flow of the liquid metal for hot dipping 18 in the snout 22. The scum 36 floating inside the snout 22 is thereby caused to flow toward the first suction portion 72 and the second suction portion 74. When this occurs, in a configuration in which a discharge region TR and a suction region are aligned with each other (for example, the configuration of FIG. 17), the flow of the liquid metal for hot dipping from the one width direction side H1 of the steel strip 14 toward the other width direction side H2 of the steel strip 14 is drawn in by the accompanying current.

In contrast thereto, the flow of the liquid metal for hot dipping from the discharge section 56 toward the first suction portion 72 and the second suction portion 74 moves away from the steel strip 14 on progression from the one width direction side H1 of the steel strip 14 to the other width direction side H2 of the steel strip 14. This suppresses movement of the scum 36 toward the steel strip 14 side by being drawn in by the accompanying current together with the liquid metal for hot dipping 18 toward the steel strip 14 side, enabling the scum 36 floating on the hot-dip plating bath surface 28 to be suppressed from adhering to the steel strip 14.

The center of the first suction portion 72 is positioned at the one thickness direction side T1 of the one thickness direction side T1 end of the discharge section 56. Moreover, the center of the second suction portion 74 is positioned at the other thickness direction side T2 of the other thickness direction side T2 end of the discharge section 56.

Thus, in comparison to cases in which the suction portions 72, 74 are respectively provided within the discharge region TR, the liquid metal for hot dipping 18 discharged by the two width direction sides of the discharge section 56 can also be caused to flow in a direction away from the steel strip 14. This enables the floating scum 36 to be suppressed from adhering to the steel strip 14.

Moreover, in the present exemplary embodiment, the first suction portion 72 and the second suction portion 74 are disposed separated by no less than 30 mm away from the extension line 60 of the steel strip 14 (CR1≥30 mm, CR2≥30 mm). Thus, in comparison to cases in which the two suction portions 72, 74 are provided less than 30 mm away from the extension line 60 of the steel strip 14, the flow of the liquid metal for hot dipping 18 discharged by the two width direction sides of the discharge section 56 can be suppressed from approaching the steel strip 14 due to the accompanying current. This enables the floating scum 36 to be suppressed from adhering to the steel strip 14.

Moreover, the respective opening widths SH1, SH2 of the first suction portion 72 and the second suction portion 74 are no less than 40 mm. Thus, in comparison to cases in which the opening widths SH1, SH2 are less than 40 mm, the region in which the liquid metal for hot dipping 18 is sucked through the suction portions 72, 74 is widened, thereby raising the removal efficiency of the floating scum 36.

In particular, due to employing the suction nozzles 71C, 71D equipped with the flow regulating function, the suction direction can be aligned with the steel strip width direction KH. The scum adhered to the inner wall faces 22D, 22E can accordingly be suppressed from dislodging, and also the rate of suction of the liquid metal for hot dipping 18 at the suction portions 72, 74 can be increased in comparison to cases lacking a flow regulating function.

Disposing the two suction nozzles 71C, 71D in this configuration at an angle so that the suction portions 72, 74 face the steel strip 14 side enables a flow of the liquid metal for hot dipping 18 in the vicinity of the inner wall faces 22D, 22E to be suppressed (see FIG. 14).

The discharge section 56 is separated by no less than 100 mm from the inner faces of the snout 22 that face the steel strip 14 entering at the steel strip entry position 29 (SR1≥100 mm, SR2≥100 mm). Thus, in comparison to cases in which there is a separation of less than 100 mm between the discharge section 56 and the inner faces, the scum 36 adhered to the inner faces of the snout 22 can be suppressed from being dislodged by the flow of liquid metal for hot dipping.

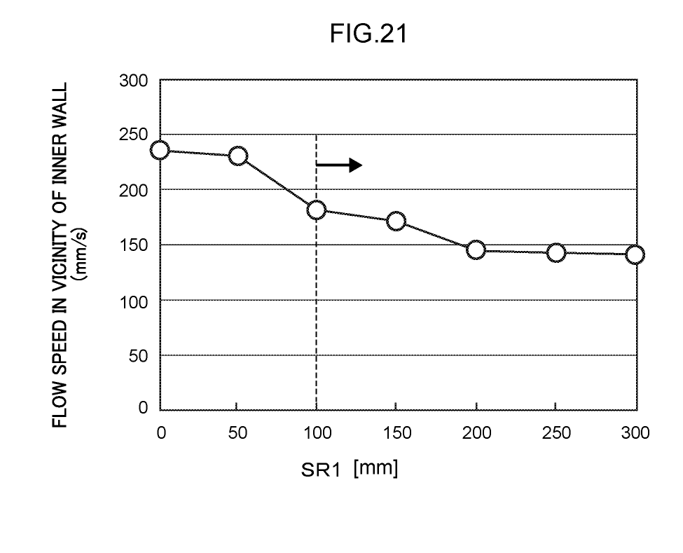

FIG. 21 illustrates results of water modeling tests (tests in a water tank) to measure changes in flow speed in the vicinity of an inner face of the snout 22 when the separation distance SR1 from one width direction end of the discharge section 56 to the one inner wall face 22D of the snout 22 is changed.

The conditions for the water modeling tests are as set out below.

Flow speed in the steel strip width direction KH at the vicinity of the discharge section 56: 250 mm/s.

Position of flow speed measurement in the vicinity of the one inner wall face 22D:

the steel strip width direction KH center.

As illustrated in FIG. 21, the flow speed in the vicinity of the inner face (the one inner wall face 22D) was confirmed to be lowered by making the separation distance SR1 no less than 100 mm, and an effect of preventing dislodging of the scum 36 adhered to the inner face can be expected.

The opening width TH of the discharge section 56 was made no less than 50 mm. The discharge rate of liquid metal for hot dipping from the discharge section 56 was thereby increased in comparison to cases in which the opening width TH was less than 50 mm, enabling an enhanced effect of preventing adherence of the scum 36 to the steel strip 14.

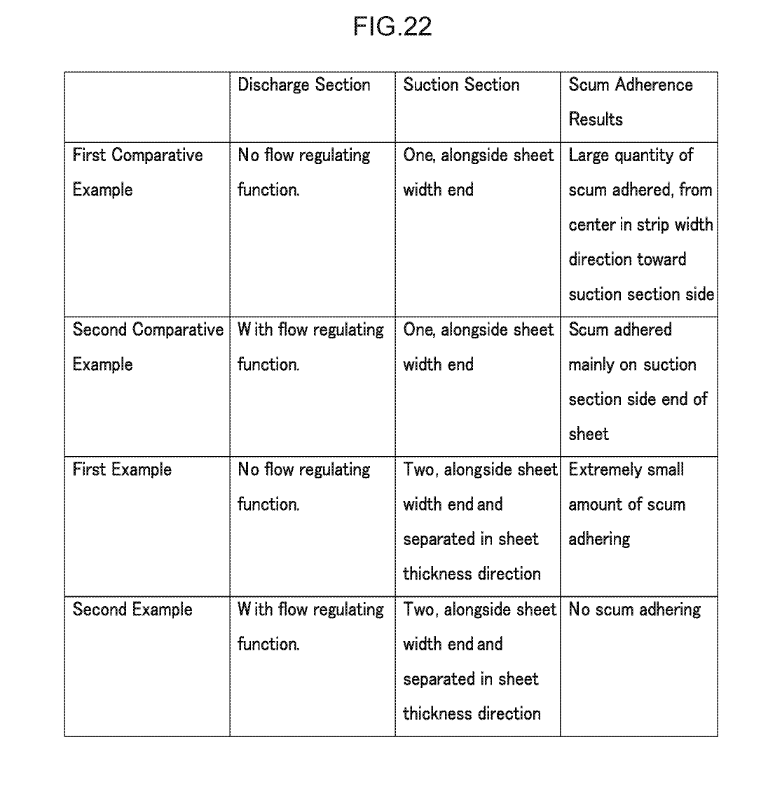

FIG. 22 is a table of test results. This table illustrates a first and second comparative example, and a first and second example.

Namely, the first comparative example is a comparative example to test the provision of a discharge section lacking a flow regulating function at the one width direction side H1, and provision of a single suction section on the extension line 60 of the steel strip 14 at the other width direction side H2 (configuration of FIG. 17). In the first comparative example a large quantity of scum adhered to the steel strip 14, from a central portion of the steel strip 14 in the steel strip width direction KH toward the suction section side.

In the second comparative example, a flow regulating function (configuration of FIG. 18) was provided to the discharge section of the first comparative example. In the second comparative example scum mainly adhered to the suction section side end portion of the steel strip 14.

The first exemplary embodiment is an example to test provision of a discharge section lacking a flow regulating function at the one width direction side H1, and provision of suction portions separated from each other and forming a pair at the one thickness direction side T1 and the other thickness direction side T2 about the extension line 60 of the steel strip 14 at the other width direction side H2. In the first example, although an extremely small amount of scum was observed adhering to the steel strip 14, a dramatic improvement in the amount adhering was achieved.

The second exemplary embodiment is the first exemplary embodiment with a flow regulating function provided to the discharge section (configuration of FIG. 19). In the second exemplary embodiment scum did not adhere to the steel strip 14.

An explanation is given below of the reference numerals.
10 scum removal device
14 steel strip
18 liquid metal for hot dipping
22 snout
22D one inner wall face
22E other inner wall face
28 hot-dip plating bath surface
36 scum
56 discharge section
60 extension line
72 first suction portion
74 second suction portion
CR1 separation distance
CR2 separation distance
H1 one width direction side
H2 other width direction side
KH steel strip width direction
KT steel strip thickness direction
SH1 opening width
SH2 opening width
SR1 separation distance
SR2 separation distance
T1 one thickness direction side
T2 other thickness direction side
TH opening width
TR discharge region

### Supplement

The following aspects may be generalized from the present specification.

Namely, a scum removal device according to a first aspect includes: a snout, the snout being inserted into a liquid metal for hot dipping in a hot-dip plating pot such that a hot-dip plating bath surface is present inside the snout; a discharge section, the discharge section being disposed on an extension line of a steel strip entry position on the hot-dip plating bath surface at one side in a steel strip width direction, and discharging the liquid metal for hot dipping; and a suction section, the suction section being disposed on the extension line on the hot-dip plating bath surface at another side in the steel strip width direction, and sucking in the liquid metal for hot dipping; the suction section being configured by a first suction portion and a second suction portion, and the first suction portion and the second suction portion being disposed separated from each other at each side of the steel strip width direction extension line of the steel strip entry position on the hot-dip plating bath surface.

A scum removal device according to a second aspect is the first aspect, wherein the discharge section includes a flow regulation plate that regulates flow of the discharged liquid metal for hot dipping so as to flow in the steel strip width direction.

A scum removal device according to a third aspect is the first or second aspect, wherein the first suction portion and the second suction portion include flow regulation plates that regulate flow of the discharged liquid metal for hot dipping so as to flow in the steel strip width direction.

A scum removal device according to a fourth aspect is the first or second aspect, wherein: the first suction portion is configured by a first pipe including an opening at a pipe leading end where the liquid metal for hot dipping is sucked in, a plane of the opening being inclined so as to open toward a steel strip entry position side; and the second suction portion is configured by a second pipe including an opening at a pipe leading end where the liquid metal for hot dipping is sucked in, a plane of the opening being inclined so as to open toward the steel strip entry position side.

A scum removal device according to a fifth aspect is the fourth aspect, wherein the first pipe and the second pipe are formed as bifurcations branching from a main pipe.

A scum removal device according to a sixth aspect is any one of the first to third aspects, wherein: the suction section is configured by a suction nozzle including a front wall facing a steel strip entry position side; the front wall of the suction nozzle is formed with: a blocking portion disposed on the extension line at the other side in the steel strip width direction and obstructing sucking in of the liquid metal for hot dipping, a first opening provided at a portion of the front wall at one side of the blocking portion and open toward the steel strip entry position side, and a second opening provided at a portion of the front wall at another side of the blocking portion and open toward the steel strip entry position side; and the first suction portion is configured by the first opening, and the second suction portion is configured by the second opening.

A scum removal device according to a seventh aspect is any one of the first to sixth aspects, wherein the discharge section is disposed at a separation of no less than 100 mm from an inner face of the snout extending along the steel strip entry position.

A scum removal method according to an eighth aspect is used in a snout inserted into a liquid metal for hot dipping in a hot-dip plating pot such that a hot-dip plating bath surface is present inside the snout, the method comprising: discharging the liquid metal for hot dipping at an extension line of a steel strip entry position on the hot-dip plating bath surface at one side in a steel strip width direction; and sucking in the liquid metal for hot dipping at another side in the steel strip width direction on the hot-dip plating bath surface, at positions separated from each other at each side of the steel strip width direction extension line of the steel strip entry position on the hot-dip plating bath surface.

The following other aspects may also be generalized from the present specification.

A first other aspect is “a scum removal device including a suction nozzle to remove scum floating on a hot-dip galvanizing bath, inside a snout connecting a reduction annealing furnace to a pot of molten zinc in equipment to manufacture hot-dip galvanized steel sheet, by sucking in the scum together with molten zinc at a hot-dip galvanizing bath surface, and the suction nozzle including a first suction nozzle disposed on one face side of a steel strip passing through inside the snout, and a second suction nozzle disposed on another face side of the steel strip”.

A second other aspect is “the scum removal device of the first other aspect, wherein the first and second suction nozzles are disposed at a snout inner end portion in a width direction of the steel strip passing through inside the snout”.

A third other aspect is “the scum removal device of the second other aspect, wherein the first and/or the second suction nozzle is disposed at least separated in the steel strip thickness direction by no less than 30 mm from the width direction extension line of the steel strip”.

A fourth other aspect is “the scum removal device of the second or third other aspect, wherein the first and/or the second suction nozzle has an opening size of at least no less than 40 mm in the steel strip thickness direction”.

The entire content of the disclosure of Japanese Patent Application No. 2015-251230 filed on Dec. 24, 2015 is incorporated by reference in the present specification.

Moreover, all publications, patent applications and technical standards mentioned in the present specification are incorporated by reference in the present specification to the same extent as if the individual publication, patent application, or technical standard was specifically and individually indicated to be incorporated by reference.

1-9. (canceled)

10. A scum removal device comprising:
a snout, the snout being inserted into a liquid metal for hot dipping in a hot-dip plating pot such that a hot-dip plating bath surface is present inside the snout;
a discharge section, the discharge section being disposed on an extension line of a steel strip entry position on the hot-dip plating bath surface at one side in a steel strip width direction, and discharging the liquid metal for hot dipping; and
a suction section, the suction section being disposed on the extension line on the hot-dip plating bath surface at another side in the steel strip width direction, and sucking in the liquid metal for hot dipping;
the suction section being configured by a first suction portion and a second suction portion, and
the first suction portion and the second suction portion being disposed separated from each other in a steel strip thickness direction at each side of the steel strip width direction extension line of the steel strip entry position on the hot-dip plating bath surface.

11. The scum removal device of claim 10, wherein the discharge section includes a flow regulation plate that regulates flow of the discharged liquid metal for hot dipping so as to flow in the steel strip width direction.

12. The scum removal device of claim 10, wherein the first suction portion and the second suction portion include flow regulation plates that regulate flow of the discharged liquid metal for hot dipping so as to flow in the steel strip width direction.

13. The scum removal device of claim 10, wherein:
the first suction portion is configured by a first pipe including an opening at a pipe leading end where the liquid metal for hot dipping is sucked in, a plane of the opening being inclined so as to open toward a steel strip entry position side; and
the second suction portion is configured by a second pipe including an opening at a pipe leading end where the liquid metal for hot dipping is sucked in, a plane of the opening being inclined so as to open toward the steel strip entry position side.

14. The scum removal device of claim 13, wherein the first pipe and the second pipe are formed as bifurcations branching from a main pipe.

15. The scum removal device of claim 10, wherein:
the suction section is configured by a suction nozzle including a front wall facing a steel strip entry position side;
the front wall of the suction nozzle is formed with:
a blocking portion disposed on the extension line at the other side in the steel strip width direction and obstructing sucking in of the liquid metal for hot dipping,
a first opening provided at a portion of the front wall at one side of the blocking portion and open toward the steel strip entry position side, and
a second opening provided at a portion of the front wall at another side of the blocking portion and open toward the steel strip entry position side; and
the first suction portion is configured by the first opening, and the second suction portion is configured by the second opening.

16. The scum removal device of claim 10, wherein the discharge section is disposed at a separation of no less than 100 mm from an inner face of the snout extending along the steel strip entry position.

17. A scum removal method for use in a snout inserted into a liquid metal for hot dipping in a hot-dip plating pot such that a hot-dip plating bath surface is present inside the snout, the method comprising:
discharging the liquid metal for hot dipping at an extension line of a steel strip entry position on the hot-dip plating bath surface at one side in a steel strip width direction; and
sucking in the liquid metal for hot dipping at another side in the steel strip width direction on the hot-dip plating bath surface, at positions separated from each other in a steel strip thickness direction at each side of the steel strip width direction extension line of the steel strip entry position on the hot-dip plating bath surface.

18. The scum removal device of claim 10, wherein:
the first suction portion is provided on one steel strip thickness direction side of the steel strip width direction extension line of the steel strip entry position on the hot-dip plating bath surface, and the second suction portion is provided on another steel strip thickness direction side of the steel strip width direction extension line;
a center of the first suction portion in the steel strip thickness direction is disposed at a position on the one steel strip thickness direction side of an end of the discharge section positioned on the one steel strip thickness direction side; and
a center of the second suction portion in the steel strip thickness direction is disposed at a position on the other steel strip thickness direction side of an end of the discharge section positioned on the other steel strip thickness direction side.
